(19) United States
(12) Patent Application Publication
(10) Pub. No.: US 2025/0376042 A1
(43) Pub. Date: Dec. 11, 2025

(54) ELECTRIC TWO-WHEELED VEHICLE DRIVING SYSTEM AND METHOD

(71) Applicant: HL MANDO CORPORATION, Gyeonggi-do (KR)

(72) Inventor: Ki Woong SHIN, Gyeonggi-do (KR)

(21) Appl. No.: 18/915,340

(22) Filed: Oct. 14, 2024

(30) Foreign Application Priority Data
Jun. 10, 2024 (KR) 10-2024-0075213

(51) Int. Cl. B60L 15/20; B62K 11/14; B62M 7/12

(52) U.S. Cl. CPC B60L 15/20; B62K 11/14; B62M 7/12; B60L 2200/12; B60L 2240/421; B60L 2240/423; B60L 2240/429; B62K 2202/00

(57) ABSTRACT

The present embodiments relate to an electric two-wheeled vehicle driving system and method. More particularly, there may provide an electric two-wheeled vehicle driving system and method capable of driving a motor by supplying a current adjusted according to a torque command value to which a torque reduction rate is applied, thereby maintaining the speed of the motor at a constant target speed and minimizing changes in the speed of the motor.

### CROSS REFERENCE TO RELATED APPLICATION

This application claims priority from Korean Patent Application No. 10-2024-0075213, filed on Jun. 10, 2024, which is hereby incorporated by reference for all purposes as if fully set forth herein.

### TECHNICAL FIELD

An embodiment of the present disclosure relates to an electric two-wheeled vehicle driving system and method for controlling a motor by supplying a current adjusted according to a torque command value to the motor to drive the motor.

### BACKGROUND

An electric two-wheeled vehicle may be configured in which a front wheel as a steering wheel and a rear wheel as a driving wheel are rotably installed in a body, and a motor for generating driving force by a power supplied from a battery is able to rotate the driving wheel to move forward.

In addition, the body may be equipped with a seat on which the user can sit in a stable posture, and a handle for turning the steering wheel of the body in a direction of travel while sitting on the seat.

In this case, the handle may be equipped with an interface device capable of displaying the status of the electric two-wheeled vehicle to the user and transmitting the user's request to a control unit through a button, a mode switch for selecting a driving mode such as forward, backward, and neutral, a throttle for accelerating a speed of the electric two-wheeled vehicle, and a brake for decelerating the speed of the electric two-wheeled vehicle.

Such an electric two-wheeled vehicle may provide mobility so that the user can easily move to the desired location. However, if the appropriate speed is not achieved, there may be a problem of unsmooth driving occurs.

Accordingly, various studies are being conducted to control the speed of the motor so as for the speed of the motor to be the determined target motor speed.

### SUMMARY

Embodiments of the present disclosure are to provide an electric two-wheeled vehicle driving system and method for controlling a motor by supplying a current adjusted according to a torque command value to the motor to drive the motor.

In accordance with an aspect of the present disclosure, there may be provided an electric two-wheeled vehicle driving system including an input device configured to detect a selected driving mode of a mode switch and detect a rotation amount of a throttle, a motor provided on one of a front wheel and a rear wheel to provide rotational power to the one of the front wheel and the rear wheel, a motor driver configured to supply current from a battery to the motor to drive the motor, and a controller configured to control the motor driver to supply current to the motor according to the rotation amount of the throttle if the throttle is rotated in a forward or reverse state, and control the motor driver to supply current to the motor according to the rotation amount of the throttle, and control the motor driver to adjust the current supplied to the motor according to a speed limit value of the motor or a speed change amount of the motor and supply the adjusted current to the motor.

In accordance with another aspect of the present disclosure, there may be provided an electric two-wheeled vehicle driving method including a torque command generation step in which a torque command generator receives a current motor speed value of a motor from a motor speed detector and determines and outputs a first torque command value according to a rotation amount of a throttle, and a current command generation step in which a current command generator controls a motor driver to drive the motor by supplying current according to the first torque command value to the motor when receiving the first torque command value from the torque command generator.

According to an embodiment of the present disclosure, it is possible to provide an electric two-wheeled vehicle driving system and method capable of driving a motor by supplying a current adjusted according to a torque command value to which a torque reduction rate is applied, thereby maintaining the speed of the motor at a constant target speed and minimizing changes in the speed of the motor.

### BRIEF DESCRIPTION OF THE DRAWINGS

FIG. 1 is a side view illustrating an electric two-wheeled vehicle according to an embodiment.

FIG. 2 is a block diagram illustrating an electric two-wheeled vehicle drive system according to an embodiment.

FIG. 3 illustrates an input device of an electric two-wheeled vehicle drive system according to an embodiment.

FIG. 4 illustrates a sensor unit of an electric two-wheeled vehicle drive system according to an embodiment.

FIG. 5 illustrates a controller of an electric two-wheeled vehicle drive system according to an embodiment.

FIG. 6 is a graph illustrating a motor speed according to a speed control torque reduction rate.

FIG. 7 is a flow chart of an electric two-wheeled vehicle drive method according to an embodiment.

FIG. 8 is an operating flow chart of an electric two-wheeled vehicle drive system according to an embodiment.

FIG. 9 is a flow chart of a torque command generation process according to an embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The “including”, terms such as “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

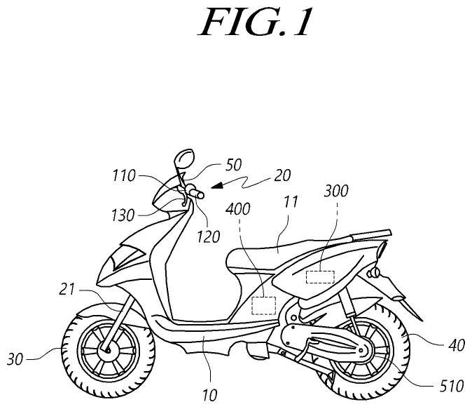

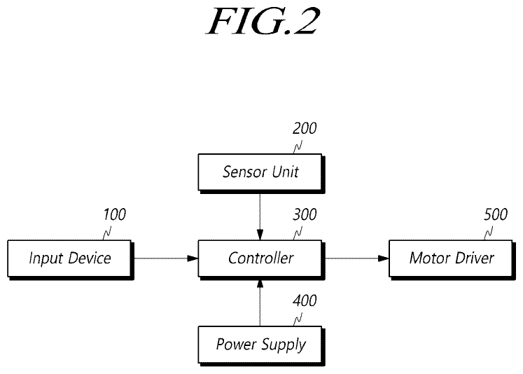

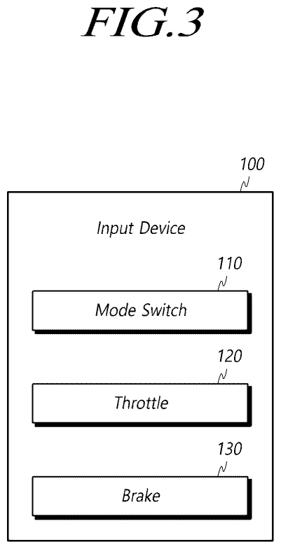

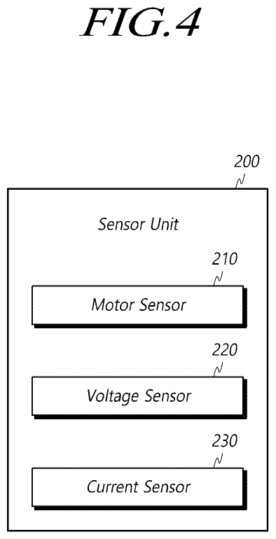

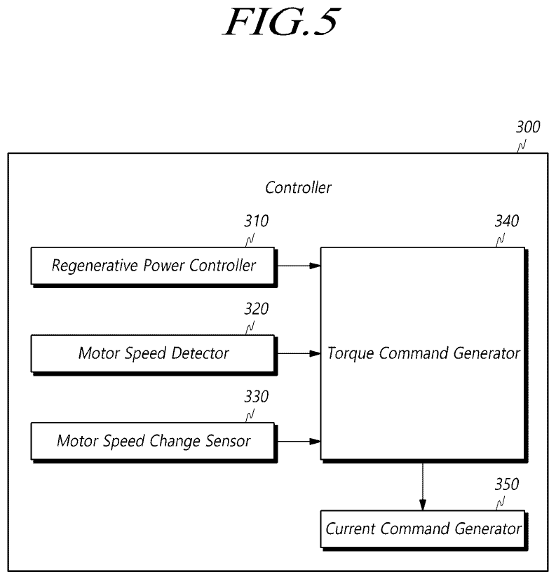

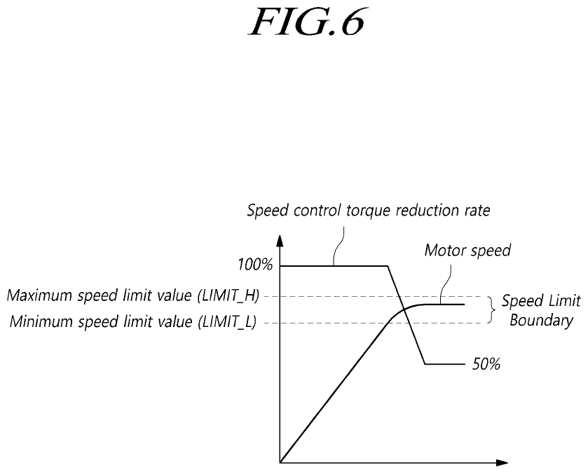

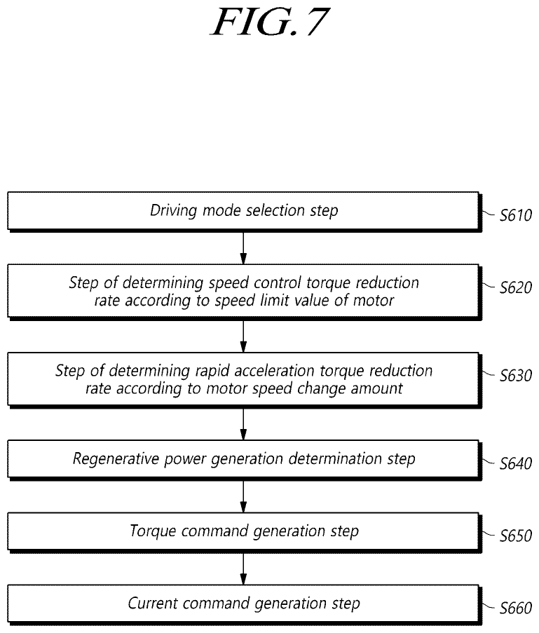

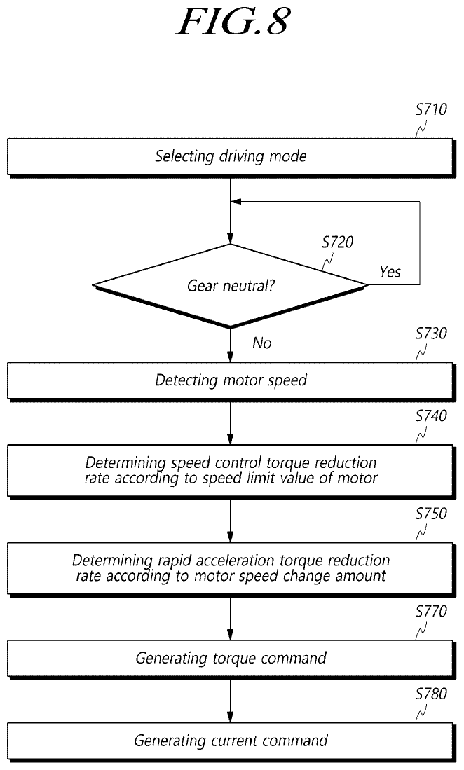

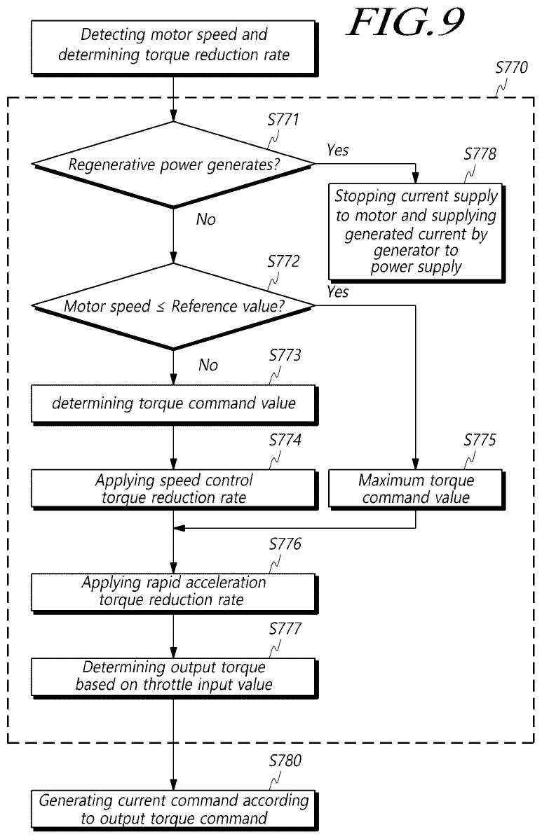

FIG. 1 is a side view illustrating an electric two-wheeled vehicle according to an embodiment, FIG. 2 is a block diagram illustrating an electric two-wheeled vehicle drive system according to an embodiment, FIG. 3 illustrates an input device of an electric two-wheeled vehicle drive system according to an embodiment, FIG. 4 illustrates a sensor unit of an electric two-wheeled vehicle drive system according to an embodiment, FIG. 5 illustrates a controller of an electric two-wheeled vehicle drive system according to an embodiment, FIG. 6 is a graph illustrating a motor speed according to a speed control torque reduction rate, FIG. 7 is a flow chart of an electric two-wheeled vehicle drive method according to an embodiment, FIG. 8 is an operating flow chart of an electric two-wheeled vehicle drive system according to an embodiment, and FIG. 9 is a flow chart of a torque command generation process according to an embodiment.

Referring to FIG. 1, an electric two-wheeled vehicle according to an embodiment of the present disclosure may include a body 10 on which a seat 11 is mounted, and a steering unit which is rotatably coupled to the body 10 and configured to change a driving direction while rotating.

The steering unit may include a handle 20 configured to change the driving direction, and a steering fork 21 which rotates together with the handle 20.

In addition, the handle 20 may include a mode switch 110 for selecting a driving mode such as forward, backward, or neutral, a throttle 120 for receiving an acceleration command from a user, and a brake 130 for decelerating the speed of the electric two-wheeled vehicle.

Here, there may be installed an interface device 50 for displaying the status of the electric two-wheeled vehicle to the user and transmitting the user's request to a controller 300 described below through a button on the handle 20.

The interface device 50 may be disposed on the handle 20, and may include a display module configured to display at least one of driving-related information (e.g., speed, travel distance, etc.), battery information, and malfunction information. In addition, the interface device 50 may be electrically connected to the controller 300.

The throttle 120 may be in the form of a lever capable of being operated by the user, and may transmit a signal indicating a throttle opening degree to the controller 300 according to the user's rotation operation.

For example, if the user turns the throttle 120 for acceleration, the controller 300 may detect the throttle opening degree according to the rotation degree of the throttle 120.

In addition, if a change in the throttle opening is detected, the controller 300 may drive a speed of a motor 510 at a preset speed. That is, the controller 300 may recognize the degree of the throttle by the user has turned the throttle and the current speed, and may control a motor driver 500 to supply current according to the corresponding torque command value to the motor 510.

In this case, the motor driver 500 may control the rotational speed of the motor 510 by supplying current according to the torque command value to the motor 510.

In addition, the electric two-wheeled vehicle may include a steering wheel 30 which is rotatably connected to the steering fork 21 and configured to roll along the ground, and a driving wheel 40 which is arranged at the rear of the steering wheel 30 and configured to roll along the ground.

In this case, the motor 510 may be installed on the body 10 and connected to the driving wheel 40, and may rotate the driving wheel by the control of the motor driver 500.

The motor 510 may be mechanically connected to the driving wheel 40 rotatably mounted on a body 10, and may generate driving force by power supplied from a battery of a power supply 400 to rotate the driving wheel 40.

Here, the electric two-wheeled vehicle of the present embodiment may be be equipped with a transmission on the motor 510 so as for a user to change the rotation speed of the driving wheel 24 by operating the interface device 50.

In addition, the body 10 may be equipped with a battery of a power supply 400 for storing electric energy and a controller 300.

Here, if the user releases the throttle or applies the brake while driving, the electric two-wheeled vehicle operates a regenerative braking logic for generating reverse torque in the motor 510 to generate power and store the generated electric energy in the battery.

In one aspect, the electric two-wheeled vehicle driving system according to the present embodiment may include an input device 100 which detects a selected driving mode by a mode switch 110 and detects a rotation amount of a throttle 120, a motor 510 which is provided on one of the front wheel and the rear wheel and provides rotational power to the wheels, a motor driver 500 which supplies current from a battery to the motor 510 to drive the motor 510, and a controller 300 which controls, if the throttle 120 is rotated in a forward or reverse state, the motor driver 500 to supply current to the motor 510 according to the rotation amount of the throttle 120 to drive the motor 510, controls the motor driver 500 to adjust the current supplied to the motor 510 according to a limited speed value of the motor 510 or the speed change amount of the motor 510 and supply the adjusted current to the motor 510.

Referring to FIGS. 2 to 5, the input device 100 may include a mode switch 110 for selecting a driving mode such as forward, reverse, or neutral, a throttle 120 for accelerating the speed of the electric two-wheeled vehicle, and a brake 130 for decelerating the speed of the electric two-wheeled vehicle.

If the input device 100 operates the mode switch 110 to a forward or reverse state and then rotates the throttle 120, the input device 100 may detect the rotation amount of the throttle 120 and transmit information on the rotation amount of the throttle 120 to the controller 300.

In this case, the controller 300 may control the motor driver 500 so that the current corresponding to the rotation amount of the throttle 120 detected by the input device 100 is supplied to the motor 510.

The brake 130 may be provided close to the throttle 120 and may decelerate the speed of the electric two-wheeled vehicle or stop the electric two-wheeled vehicle by the user's operation.

The motor 510 may be provided on either the front or rear wheel, and may provide rotational power to the wheel.

The motor driver 500 may drive the motor 510 by supplying driving current to the motor 510 according to a torque command value of the controller 300.

Here, the electric two-wheeled vehicle may control the driving speed by controlling the current supplied to the motor 510.

That is, when the throttle 120 is rotated, the electric two-wheeled vehicle may control the driving speed by controlling the motor driver 500 according to the rotation amount of the throttle 120 and adjusting the current supplied to the motor 510.

In this case, the rotation amount of the throttle 120 may increase or decrease linearly, and the current may also increase or decrease linearly in proportion to the rotation amount of the throttle 120.

If the controller 300 rotates the throttle 120 in a forward or backward state, the controller 300 may control the motor driver 500 to supply current to the motor 510 according to the rotation amount of the throttle 120 to drive the motor 510.

In this case, the controller 300 may control the motor driver 500 to adjust the current supplied to the motor 510 according to the speed limit value of the motor 510 or the speed change amount of the motor 510 and supply the adjusted current to the motor 510.

More specifically, the controller 300 may include a torque command generator 340 which receives a current motor speed value of the motor 510 from a motor speed detector 320 and determines and outputs a first torque command value according to the rotation amount of the throttle 120, and a current command generator 350 which controls the motor driver 500 to drive the motor 510 by supplying current according to the first torque command value to the motor 510 in response to receiving of the first torque command value from the torque command generator 340.

The torque command generator 340 may receive the current motor speed value of the motor 510 from the motor speed detector 320 through the motor sensor 210 and determine and output the first torque command value according to the rotation amount of the throttle 120.

As shown in Equation 1, the first torque command value may be determined by multiplying an input maximum voltage value by an input maximum current value and the constant value 9.5492, dividing the multiplied value by the current motor speed value of the motor 510, and multiplying it by the preset efficiency compensation value.

$$First Torque Command Value = ↵ ⌊ \frac{\begin{matrix}Input Maximum Voltage \times \\ Input Maximum Current \times 9.5492 )\end{matrix}}{( Current Motor Speed Value )} ⌋ \times Efficiency Compensation Value ↵ \qquad [ Equation 1 ]$$

Here, the input maximum voltage value may be a rated voltage of an inverter, the input maximum current value may be the maximum current input to the inverter, and the efficiency compensation value may be a value for compensating an output torque.

In this case, the voltage value may be provided through a voltage sensor 220 of a sensor unit 200, and the current value may be provided through a current sensor 230 of the sensor unit 200.

Then, if the first torque command value of the torque command generator 340 is input, the current command generator 350 may control the motor driver 500 to supply current according to the first torque command value to the motor 510 to drive the motor 510.

In this case, when the throttle 120 rotates, if a detected output torque of the motor 510 is higher than an output torque of the motor 510 set to the rotation amount of the throttle 120, the torque command generator 340 may adjust and output the first torque command value.

Here, the torque command generator 340 may receive the current motor speed value from the motor speed detector 320 and determine a speed control torque reduction rate if the current motor speed value is higher than a preset minimum speed limit value of the motor 510, and output a second torque command value by applying the speed control torque reduction rate to the first torque command value.

In addition, the current command generator 350 may control the motor driver 500 to drive the motor 510 by supplying a current adjusted according to the second torque command value to the motor 510 in response to the input of the second torque command value from the torque command generator 340.

In this case, as shown in Equation 2, the speed control torque reduction rate may be determined as a value obtained by dividing a first value obtained by subtracting the current motor speed value from a preset maximum speed limit LIMIT_H value by a second value obtained by subtracting the minimum speed limit value LIMIT_L from the maximum speed limit value LIMIT_H.

$$Speed Control Torque Reduction Rate = \frac{( {LIMIT}_{H} - Current Motor Speed Value )}{( {LIMIT}_{H} - {LIMIT}_{L} )} \qquad [ Equation 2 ]$$

For example, as shown in FIG. 6, if the speed of the motor 510 increases, and the current motor speed value increases more than the minimum speed limit value of the motor 510, the second torque command value may be determined as a value obtained by multiplying the first torque command value by the speed control torque reduction rate to maintain a value between the maximum speed limit value of the motor 510 and the minimum speed limit value of the motor 510.

On the other hand, the torque command generator 340 may output the first torque command value if the current motor speed value is less than the preset minimum speed limit value of the motor 510.

In addition, if the first torque command value of the torque command generator 340 is input, the current command generator 350 may control the motor driver 500 to supply current according to the first torque command value to the motor 510 to drive the motor 510.

In addition, if a speed change amount of the motor 510 is greater than or equal to a preset reference value, the torque command generator 340 may receive the speed change amount from a motor speed change detector 330, determine a rapid acceleration torque reduction rate, and output a third torque command value by applying the rapid acceleration torque reduction rate to the first torque command value or the second torque command value.

In addition, if the third torque command value of the torque command generator 340 is input, the current command generator 350 may control the motor driver 500 to supply the motor 510 with the current adjusted according to the third torque command value to drive the motor 510.

In this case, rapid acceleration torque reduction rate may be determined as a value obtained by dividing a preset adjustment value plus 1 by the speed change amount, as shown in Equation 3.

$$[ Equation 3 ]$$

$$Rapid Acceleration Torque Reduction Rate = \frac{( 1 + Adjustment Value )}{speed change amount}$$

In this embodiment, if the current motor speed value decreases below the minimum speed limit value of the motor 510, the third torque command value may be determined as a value obtained by multiplying the first torque command value by the rapid acceleration torque reduction rate by receiving the speed change amount from the motor speed change detector 330.

On the other hand, if the current motor speed value increases above the minimum speed limit value of the motor 510, the third torque command value may be determined as a value obtained by multiplying the second torque command value by the rapid acceleration torque reduction rate by receiving the speed change amount from the motor speed change detector 330.

Here, the motor speed change detector 330 may receive a speed value of the motor 510 from the motor speed detector 320 at a preset time interval, compare the current motor speed value with the previous motor speed value, may determine the speed change amount between the current motor speed value and the previous motor speed value. If the determined speed change amount is greater than a preset reference value, the speed change amount may be provided to the torque command generator 340.

In this case, the motor speed change detector 330 may receive the speed value of the motor 510 from the motor speed detector 320 at a preset time interval, compare the current motor speed value with the previous motor speed value, determine the speed change amount between the current motor speed value and the previous motor speed value, and accumulate and store the determined speed change amount.

In addition, the motor speed change detector 330 may monitor the generated speed change amount and output the speed change amount when determining an occurrence of a rapid speed change. In this case, the torque command generator 340 may receive the speed change amount, determine the rapid acceleration torque reduction rate, and output the third torque command value by applying the rapid acceleration torque reduction rate to the first torque command value or the second torque command value.

In addition, the torque command generator 340 may output the first torque command value or the second torque command value if the speed change amount input from the motor speed change detector 330 is smaller than the reference value.

In addition, if the first torque command value or the second torque command value is transmitted from the torque command generator 340, the current command generator 350 may control the motor driver 500 to supply the current adjusted according to the first torque command value or the second torque command value to the motor 510 to drive the motor 510.

That is, the current command generator 350 may control the current supplied to the motor 510 according to the torque command value and control the motor driver 500 to supply the adjusted current to the motor 510, thereby controlling the driving speed through the control of the motor driving.

Here, when the controller 300 may determine that regenerative power is generated from a regenerative power controller 310, and the control unit 300 may stop supplying current to the motor 510 and supply the current generated by a generator to the power supply 400.

In another aspect, the electric two-wheeled vehicle driving method according to the present embodiment may include: a driving mode selection step (S610) for detecting a selected driving mode of a mode switch 110 and detecting a motor speed and a rotation amount of a throttle 120; a speed control torque reduction rate determinion step (S620) of determining the speed control torque reduction rate according to a speed limit value of a motor 510; a rapid acceleration torque reduction rate determinion step (S630) of determining the rapid acceleration torque reduction rate according to a speed change amount of a motor 510; a regenerative power generation determination step (S640) for stopping the current supply to the motor 510 and supplying a current generated by a generator to the power supply 400 if it is determined that regenerative power is generated from a regenerative power controller 310; a torque command generation step (S650) in which a torque command generator 340 receives a current motor speed value of the motor 510 from a motor speed detector 320 and determines and outputs a first torque command value according to the rotation amount of the throttle 120; and a current command generation step (S660) in which, when receiving the first torque value from the torque command generator 340, the current command generator 350 controls the motor driver 500 to supply current according to the first torque command value to the motor 510 to drive the motor 510.

Referring to FIGS. 7 to 9, in the driving mode selection step (S610), a driving mode such as forward, backward, and neutral may be selected by operating the mode switch 110. (S710)

In addition, the user may operate the throttle 120 to accelerate the speed of the electric two-wheeled vehicle in the driving mode, or may operate the brake 130 to decelerate the speed of the electric two-wheeled vehicle.

In this case, in the driving mode selection step (S610), if the mode switch 110 is operated to the forward or reverse state and the throttle 120 is rotated, the input device 100 may detect the rotation amount of the throttle 120 and transmit information on the rotation amount of the throttle 120 to the controller 300. (S720)

Here, the controller 300 may control the motor driver 500 so that the current corresponding to the rotation amount of the throttle 120 detected by the input device 100 is supplied to the motor 510.

Accordingly, the motor driver 500 may supply a driving current to the motor 510 by the current control of the controller 300 to drive the motor 510, and the motor 510 may provide rotational power to the wheels.

The electric two-wheeled vehicle of an embodiment may control the driving speed by controlling the current supplied to the motor 510.

That is, if the throttle 120 rotates, the current supplied to the motor 510 may be adjusted according to the rotation amount of the throttle 120, thereby controlling the driving speed.

In this case, the rotation amount of the throttle 120 may increase or decrease linearly, and the current may increase or decrease linearly in proportion to the rotation amount of the throttle 120.

In the speed control torque reduction rate determinion step (S620), the motor speed detector 320 may detect the motor speed through the motor sensor 210 of the sensor unit 200 (S730), determine and output the current motor speed value of the motor 510 using the detected motor speed. In addition, the torque command generator 340 may determine the speed control torque reduction rate according to the speed limit value of the motor 510. (S740)

In this case, the speed control torque reduction rate may be determined as a value obtained by dividing a first value obtained by subtracting the current motor speed value from a preset maximum speed limit LIMIT_H value by a second value obtained by subtracting the minimum speed limit value LIMIT_L from the maximum speed limit value LIMIT_H, as the Equation 2.

In the rapid acceleration torque reduction rate determinion step (S630), the motor speed detector 320 may detect the motor speed through the motor sensor 210 of the sensor unit 200 (S730), determine and output the current motor speed value of the motor 510 using the detected motor speed. In addition, the torque command generator 340 may determine the rapid acceleration torque reduction rate according to the speed change amount of the motor 510. (S750) In this case, the rapid acceleration torque

reduction rate may be determined as a value obtained by adding 1 to a preset adjustment value and dividing the value by the speed change amount, as shown in the Equation 3.

In the regenerative power generation determination step (S640), if it is determined that regenerative power is generated, a regenerative power controller 310 may stop supplying current to the motor 510 and supply the generated current to the power supply (400. (S771)

In the torque command generation step (S650), the torque command generator 340 may receive the current motor speed value of the motor 510 from the motor speed detector 320 and determine and output the first torque command value according to the rotation amount of the throttle 120. (S770)

In this case, in the torque command generation step (S650), if the detected output torque of the motor 510 is higher than an output torque of the motor 510 set to the rotation amount of the throttle 120 when the throttle 120 is rotated, the torque command generator 340 may adjust and output the first torque command value.

In addition, when the first torque command value of the torque command generator 340 is input to the current command generator 350 in the current command generation step (S660), the current command generator 350 may control the motor driver 500 to supply current according to the first torque command value to the motor 510 to drive the motor 510. (S780)

That is, in the current command generation step (S660), if the throttle 120 is rotated in a forward or reverse state, the controller 300 may control the motor driver 500 to supply current to the motor 510 according to the rotation amount of the throttle 120 to drive the motor 510.

In this case, in the current command generation step (S660), the controller 300 may control the motor driver 500 to adjust the current supplied to the motor according to the speed limit value of the motor 510 or the speed change amount of the motor 510 and supply the adjusted current to the motor 510.

In addition, in the torque command generation step (S650), if it is determined that regenerative power is generated (S771), the regenerative power controller 310 may stop supplying current to the motor 510 and supply the generated current to the power supply 400. (S778)

In the torque command generation step (S650), if the motor speed is lower than or equal to a reference value (S772), the torque command generator 340 may output a maximum torque command value. (S775)

Here, the reference value may include either a preset maximum speed limit value LIMIT_H of the motor 510 or a preset minimum speed limit value LIMIT_L of the motor 510.

That is, in the torque generation step (S650), if the current motor speed value is higher than the preset minimum speed limit value of the motor 510 (S772), the torque command generator 340 may receive the current motor speed value from the motor speed detector 320 and determines the speed control torque reduction rate (S773), and apply the speed control torque reduction rate to the first torque command value to output the second torque command value. (S774)

Then, in the current command generation step (S660), if the second torque command value of the torque command generator 340 is input to the current command generator 350, the current command generator 350 may control the motor driver 500 to supply the current adjusted according to the second torque command value to the motor 510 to drive the motor 510. (S780)

As shown in FIG. 6, if the speed of the motor 510 increases and the current motor speed value increases above the minimum speed limit value of the motor 510, the second torque command value may be determined as a value obtained by multiplying the first torque command value by the speed control torque reduction rate to maintain a value between the maximum speed limit value of the motor 510 and the minimum speed limit value of the motor 510.

On the other hand, in the torque command generation step (S650), if the current motor speed value is less than the preset minimum speed limit value of the motor 510, the torque command generator 340 may output the first torque command value. (S775)

In the current command generation step (S660), if the first torque command value of the torque command generator 340 is input to the current command generator 350, the current command generator 350 may control the motor driver 500 to supply current according to the first torque command value to the motor 510 to drive the motor 510. (S780)

In addition, in the torque command generation step (S650), if the speed change amount of the motor 510 is greater than or equal to the preset reference value, the torque command generator 340 may receive the motor speed change amount from the motor speed change detector 330, determine the rapid acceleration torque reduction rate, and output the third torque command value by applying the rapid acceleration torque reduction rate to the first torque command value or the second torque command value. (S776)

In addition, in the current command generation step (S660), if the third torque command value of the torque command generator 340 is input to the current command generator 350, the current command generator 350 may control the motor driver 500 to supply the current adjusted according to the third torque command value to the motor 510 to drive the motor 510. (S780)

In the embodiment, if the current motor speed value decreases below the minimum speed limit value of the motor 510, the third torque command value may be determined as a value obtained by multiplying the first torque command value by the rapid acceleration torque reduction rate by receiving the speed change amount from the motor speed change detector 330.

On the other hand, if the current motor speed value increases more than the minimum speed limit value of the motor 510, the third torque command value may be determined as a value obtained by multiplying the second torque command value by the rapid acceleration torque reduction rate by receiving the speed change amount from the motor speed change detector 330.

In this case, in the torque command generation step (S650), the motor speed change detector 330 may receive the speed value of the motor 510 from the motor speed detector 320 at a preset time interval, compare the current motor speed value with the previous motor speed value, determine the speed change amount between the current motor speed value and the previous motor speed value. In addition, if the determined speed change amount is greater than a preset reference value, the speed change amount may be provided to the torque command generator 340.

In addition, in the torque command generation step (S650), the motor speed change detector 330 may receive the speed value of the motor 510 from the motor speed detector 320 at a preset time interval, compare the current motor speed value with the previous motor speed value, determine the speed change amount between the current motor speed value and the previous motor speed value, and accumulate and store the determined speed change amount.

In addition, in the torque command generation step (S650), the motor speed change detector 330 may monitor the determined speed change amount and output the speed change amount when determining an occurrence of a rapid speed change. In this case, the torque command generator 340 may receive the speed change amount, determine the rapid acceleration torque reduction rate, and output the third torque command value by applying the rapid acceleration torque reduction rate to the first torque command value or the second torque command value.

In addition, in the torque command generation step (S650), the torque command generator 340 may output the first torque command value or the second torque command value if the speed change amount input from the motor speed change detector 330 is smaller than the reference value.

In addition, in the current command generation step (S660), if the first torque command value or the second torque command value of the torque command generator 340 is input to the current command generator 350, the current command generator 350 may control the motor driver 500 to supply the current adjusted according to the first torque command value or the second torque command value to the motor 510 to drive the motor 510.

That is, the current command generator 350 may control the current supplied to the motor 510 according to the torque command value and control the motor driver 500 to supply the adjusted current to the motor 510, thereby controlling the driving speed through the control of the driving of the motor 510.

Accordingly, in the torque command generation step (S650), the torque command generator 340 may output the first torque command value, the second torque command value to which the speed control torque reduction rate is applied, or the third torque command value to which the rapid acceleration torque reduction rate is applied, according to an input value of the throttle 120. (S777)

According to the present embodiments, by supplying the current adjusted according to the torque command value to which a torque reduction rate is applied to the motor 510 to drive the motor 510, it is possible to maintain the speed of the motor 510 at a target speed to drive the vehicle, and it is possible to minimize the speed change of the motor 510.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. An electric two-wheeled vehicle driving system comprising:
an input device configuring to detect a selected driving mode of a mode switch and detect a rotation amount of a throttle;
a motor provided on one of a front wheel and a rear wheel to provide rotational power to the one of the front wheel and the rear wheel;
a motor driver configuring to supply current from a battery to the motor to drive the motor; and
a controller configuring to control the motor driver to supply current to the motor according to the rotation amount of the throttle if the throttle is rotated in a forward or reverse state, and control the motor driver to adjust the current supplied to the motor according to a speed limit value of the motor or a speed change amount of the motor and supply the adjusted current to the motor.

2. The electric two-wheeled vehicle driving system of claim 1, wherein the controller comprises:
a torque command generator configuring to receive a current motor speed value of the motor from a motor speed detector, and determine and output a first torque command value according to the rotation amount of the throttle; and
a current command generator configuring to control the motor driver to drive the motor by supplying current according to the first torque command value to the motor when receiving the first torque command value from the torque command generator.

3. The electric two-wheeled vehicle driving system of claim 2, wherein the torque command generator adjusts and outputs the first torque command value if a detected output torque of the motor is higher than an output torque of the motor set for the rotation amount of the throttle when the throttle rotates.

4. The electric two-wheeled vehicle driving system of claim 2, wherein, if the current motor speed value is greater than or equal to a preset minimum speed limit value of the motor, the torque command generator receives the current motor speed value from the motor speed detector, determines a speed control torque reduction rate, and outputs a second torque command value by applying the speed control torque reduction rate to the first torque command value,
wherein, in response to receive the second torque command value from the torque command generator, the current command generator controls the motor driver to drive the motor by supplying a current adjusted according to the second torque command value to the motor.

5. The electric two-wheeled vehicle driving system of claim 4, wherein the speed control torque reduction rate is a value obtained by dividing a first value obtained by subtracting the current motor speed value from a preset maximum speed limit value by a second value obtained by subtracting the minimum speed limit value from the maximum speed limit value.

6. The electric two-wheeled vehicle driving system of claim 4, wherein, if the speed change amount of the motor is greater than or equal to a preset reference value, the torque command generator receives the speed change amount from a motor speed change detector, determines a rapid acceleration torque reduction rate, and outputs a third torque command value by applying the rapid acceleration torque reduction rate to the first torque command value or the second torque command value,
wherein, in response to receive the third torque command value from the torque command generator, the current command generator controls the motor driver to drive the motor by supplying a current adjusted according to the third torque command value to the motor.

7. The electric two-wheeled vehicle driving system of claim 6, wherein the rapid acceleration torque reduction rate is a value obtained by dividing a third value obtained by adding 1 to a preset adjustment value by the speed change amount.

8. The electric two-wheeled vehicle driving system of claim 6, wherein, if the speed change amount input from the motor speed change detector is less than the reference value, the torque command generator outputs the first torque command value or the second torque command value,
wherein, in response to receive the first torque command value or the second torque command value from the torque command generator, the current command generator controls the motor driver to drive the motor by supplying a current adjusted according to the first torque command value or the second torque command value to the motor.

9. The electric two-wheeled vehicle driving system of claim 1, wherein, if it is determined that a regenerative power is generated from a regenerative power controller, the controller stops supplying current to the motor and supplies the generated current by the regenerative power to a power supply.

10. The electric two-wheeled vehicle driving system of claim 1, wherein the rotation amount of the throttle increases or decreases linearly, and the current increases or decreases linearly in proportion to the rotation amount of the throttle.

11. An electric two-wheeled vehicle driving method comprising:
a torque command generation step in which a torque command generator receives a current motor speed value of a motor from a motor speed detector, and determines and outputs a first torque command value according to a rotation amount of a throttle; and
a current command generation step in which a current command generator controls a motor driver to drive the motor by supplying current according to the first torque command value to the motor when receiving the first torque command value from the torque command generator.

12. The electric two-wheeled vehicle driving method of claim 11, further comprising, before torque command generation step, a driving mode selection step of detecting a selected driving mode of a mode switch and detecting the current motor speed value of the motor and the rotation amount of the throttle.

13. The electric two-wheeled vehicle driving method of claim 12, wherein the torque command generation step comprises adjusting and outputting the first torque command value if a detected output torque of the motor is higher than an output torque of the motor set for the rotation amount of the throttle when the throttle rotates.

14. The electric two-wheeled vehicle driving method of claim 12, wherein, in the torque command generation step, if the current motor speed value is greater than or equal to a preset minimum speed limit value of the motor, the torque command generator receives the current motor speed value from the motor speed detector, determines a speed control torque reduction rate, and outputs a second torque command value by applying the speed control torque reduction rate to the first torque command value,
wherein, in the current command generation step, when the second torque command value is inputted into the current command generator from the torque command generator, the current command generator controls the motor driver to drive the motor by supplying a current adjusted according to the second torque command value to the motor.

15. The electric two-wheeled vehicle driving method of claim 14, wherein the speed control torque reduction rate is a value obtained by dividing a first value obtained by subtracting the current motor speed value from a preset maximum speed limit value by a second value obtained by subtracting the minimum speed limit value from the maximum speed limit value.

16. The electric two-wheeled vehicle driving method of claim 14, wherein, in the torque command generation step, if a speed change amount of the motor is greater than or equal to a preset reference value, the torque command generator receives the speed change amount from a motor speed change detector, determines a rapid acceleration torque reduction rate, and outputs a third torque command value by applying the rapid acceleration torque reduction rate to the first torque command value or the second torque command value,
wherein, in the current command generation step, in response to receive the third torque command value from the torque command generator, the current command generator controls the motor driver to drive the motor by supplying a current adjusted according to the third torque command value to the motor.

17. The electric two-wheeled vehicle driving method of claim 16, wherein the rapid acceleration torque reduction rate is a value obtained by dividing a third value obtained by adding 1 to a preset adjustment value by the speed change amount.

18. The electric two-wheeled vehicle driving method of claim 16, wherein, in the torque command generation step, if the speed change amount input from the motor speed change detector is less than the reference value, the torque command generator outputs the first torque command value or the second torque command value,
wherein, in the current command generation step, in response to receive the first torque command value or the second torque command value from the torque command generator, the current command generator controls the motor driver to drive the motor by supplying a current adjusted according to the first torque command value or the second torque command value to the motor.

19. The electric two-wheeled vehicle driving method of claim 11, further comprising, before the torque command generation step, a regenerative power generation determination step in which, if it is determined that a regenerative power is generated from a regenerative power controller, the regenerative power controller stops supplying current to the motor and supplies the generated current by the regenerative power to a power supply.

20. The electric two-wheeled vehicle driving method of claim 11, wherein the rotation amount of the throttle increases or decreases linearly, and the current increases or decreases linearly in proportion to the rotation amount of the throttle.
